(19) United States
(12) Patent Application Publication
(10) Pub. No.: US 2013/0103281 A1
(43) Pub. Date: Apr. 25, 2013

(54) Motorcycle traction control system

(71) Applicant: Ben Daniels, Chestnut Hill, MA (US)

(72) Inventor: Ben Daniels, Chestnut Hill, MA (US)

(73) Assignee: SABERTOOTH MOTORCYCLES, LLC, Chestnut Hill, MA (US)

(21) Appl. No.: 13/657,811

(22) Filed: Oct. 22, 2012

Related U.S. Application Data
(60) Provisional application No. 61/549,721, filed on Oct. 20, 2011.

(51) Int. Cl. B60T 8/175; B60W 10/184; B60W 10/04

(52) U.S. Cl. 701/83

(57) ABSTRACT

A traction control system for two and three wheeled motorcycles that prevents or limits the rear wheel(s) from slipping when the operator accelerates the vehicle. If the torque supplied by the motor exceeds the tractive force developed between the rear tire(s) and the road surface the rear tire(s) will slip creating a dangerous condition. The operator engages the system and selects the degree of desired traction control. The system detects rear (driven) and front (non-driven) wheel rotational speeds. If the rear wheel(s) begins rotating faster than the front wheel(s) the traction control computer will send a signal to the motor control unit to reduce the motor's power output. Additionally, as the operator applies the throttle the traction control computer sends a signal is sent to the rear suspension to stiffen for the purpose of more efficiently transmitting power to the rear wheel(s) and road surface.

### FIELD OF THE INVENTION

The present invention relates to a traction control system for two and three wheeled motorcycles and, more particularly, to a system that at the operator's discretion limits or prevents the rear wheel(s) from slipping under hard acceleration.

### BACKGROUND OF THE INVENTION

Two and three wheeled motorcycles powered by powerful motors (example large displacement V8 automobile motors) have significantly greater power to weight ratios than virtually all other vehicles designed for on-road use. If the torque generated by the motor transmitted to the rear wheel(s) exceeds the tractive force between the rear tire(s) and the road surface the tire(s) will not be able to maintain traction and begin to slip, i.e. it will begin to rotate faster than the vehicle's tire(s) that are not driven by the motor. The tractive force generated between a tire and the road surface is a function of a number of factors including vehicle weight, the downward force applied to the tire, the area of tire contact with the road surface, material composition of the tire, condition of the road surface, temperature, and other factors. Many two and three wheeled motorcycles exist whose motors are capable of generating torque that exceeds the tractive force the rear tire(s) can generate. The faster a vehicle is travelling the more power that is required to propel it and the less likely it is for the rear wheel(s) to slip on a good road surface, however the aforementioned vehicles have sufficient power that they are capable of slipping their rear tire(s) even at high speeds on a good road surface. Two wheeled motorcycles are equipped with a single rounded rear tire resulting in a relatively small contact patch with the road surface. Three wheeled motorcycles commonly are equipped with two rear tires (although some three wheeled motorcycles exist that have two wheels in the front and one in the rear), however they still have a relatively small tire contact patch with the road surface compared to the torque produced by the vehicle's motor. As a result, it is relatively easy for the operator to inadvertently cause the rear tire(s) to slip when accelerating even under ideal road conditions.

Operators of two and three wheeled motorcycles commonly desire to be able to accelerate as rapidly as possible. Because of the high power to weight ratio, even very skilled and experienced operators have difficulty achieving this without slipping the back tire(s) because the more torque that is transferred to the rear wheel(s) and tire(s) the faster the motorcycle will accelerate until the instant the maximum tractive force between the tire(s) and the road surface is exceeded and the tire(s) begin slipping. Ideally operators would like to be able to completely open the throttle without having to be concerned about slipping the back tire(s) and therefore be able to concentrate on steering and operating the motorcycle, not on adjusting the throttle to prevent the tire(s) from slipping. Once the rear tire(s) begin slipping the motorcycle will not accelerate efficiently as the tire(s) are no longer in firm contact with the road surface.

An unsafe condition is created as soon as the back tire(s) lose traction and begin slipping. Once the rear tire(s) begins slipping it is no longer firmly in contact with the road surface and the rear end of the motorcycle can fishtail and move in a sideways direction which can cause the operator to lose control of the motorcycle and crash. The danger of this occurring is increased the faster the vehicle is travelling when the loss of traction occurs.

Under hard acceleration a portion of the energy from the motor is used to compress the rear suspension of the two or three wheeled motorcycle and is thus not available for accelerating the vehicle. A rigid (no rear suspension) design is the most efficient for transferring power to the rear wheel(s) particularly when on a smooth road surface, however as there is no rear shock absorbing the vehicle will tend to bounce when on a bumpy or uneven road surface resulting in diminished traction, and a poor quality ride for the operator and passenger. Any bouncing of the rear wheel(s) can cause the rear wheel(s) to lose contact with the road surface thus reducing traction and increasing the likelihood it will begin slipping. Additionally, operators and passengers have come to expect the superior ride quality and comfort of vehicles with rear suspensions, particularly independent rear suspensions.

In a three wheeled motorcycle with two driven rear wheels it is likely that one wheel will lose traction and commence slipping before the other one.

Traction control systems exist for automobiles that measure the individual wheels rotational speeds and reduce motor power if any slippage of any driven wheel is detected. These systems are generally integrated with the antilock braking systems and automatically apply the brakes to any wheel that is slipping to cause it to slow to the speed of the vehicle's other wheels. These systems generally do not allow the operator to selectively turn off parts of the system such as the antilock braking system component or for the operator to select the degree to which the computer retards the throttle to stop any slippage of the rear wheel.

Existing traction control systems are not designed for use in two or three wheel motorcycles powered by powerful motors.

The existing automotive traction control systems are designed for use in vehicles with much smaller power to weight ratios. In the vehicles these systems are designed for drive wheel slippage generally only occurs under adverse road conditions and not under good road condition at vehicle high speeds. As a result these systems are not designed to prevent wheel slippage occurring under good road conditions at high vehicle speeds with the operator holding the throttle wide open. Because of the much greater power to weight ratio of two and three wheel motorcycles powered by powerful motors it is relatively easy for the rear tire(s) to slip at high speed under good road conditions even if the operator is non trying to do so. Additionally, existing automotive traction control systems do not have operator selectable settings that allow the rear wheel(s) to slip by a preset percentage.

A number of rigid motorcycle frame designs exist that do not have any rear suspension. While these designs efficiently transfer power to the rear wheel under good road conditions, they do not perform well when travelling on bumpy or uneven roads and provide an uncomfortable quality ride for the operator and passenger.

Active suspension systems exist that adjust rear suspension damping however they are not designed to become rigid when the vehicle is accelerated rapidly nor or they designed for use in two or three wheel motorcycles.

It would be advantageous to provide a system that reduces and/or eliminates rear wheel slippage under hard acceleration.

It would also be advantageous to provide a system that reduces and/or eliminates rear wheel slippage in wet and/or slippery road conditions.

It would further be advantageous to provide a system that increases rear wheel traction.

It would further be advantageous to provide a system that allows the operator to accelerate without fear of the rear tire slipping.

It would further be advantageous to provide a system that allows the operator to select the degree to which the system reduces and/or eliminates rear wheel slippage.

It would further be advantageous to provide a system that improves performance.

It would further be advantageous to provide a system that improves handling.

It would further be advantageous to provide a system that increases safety.

### SUMMARY OF THE INVENTION

In accordance with the present invention, there is provided a traction control system that prevents or limits the rear wheel from slipping when the throttle is applied by the operator. If motor power exceeds rear tire tractive force tire will begin slipping creating a dangerous condition. The system detects ground vehicle speed through a speed sensor mounted on the front wheel and the rotational speeds of all the wheels. As the operator applies the throttle, if the rear wheel begins rotating faster than the front wheel the traction control computer will send a signal to the motor control unit computer to reduce the throttle to the extent necessary to stop or limit the wheel slipping. Additionally, under hard acceleration a signal will be sent to the rear shock absorbers to stiffen them so motor power is more efficiently transferred to the rear wheel.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a left view of a complete two wheel motorcycle with the invention installed;

FIG. 2 is a detail view of a schematic of the components and connections in a two wheel motorcycle of the invention;

FIG. 3 is a left view of a complete three wheel motorcycle with the invention installed; and

FIG. 4 is a detail view of a schematic of the components and connections in a three wheel motorcycle of the invention.

For purposes of clarity and brevity, like elements and components will bear the same designations and numbering throughout the Figures.

### DESCRIPTION OF THE PREFERRED EMBODIMENT

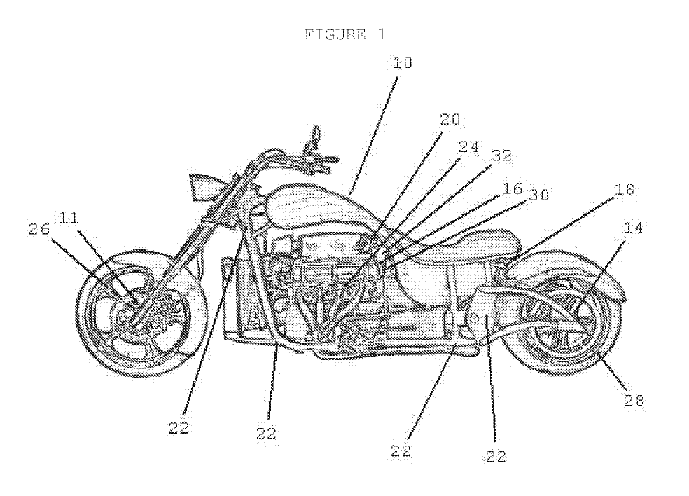

FIG. 1 is a left view of a complete two wheel motorcycle 10 with the invention installed and shows the configuration of the invention when installed in a two wheel motorcycle or three wheel motorcycle having two wheels in the front and one wheel in the rear which contains a frame 22 which provides structure for the motorcycle and a place to attach other components. At the front end is mounted a front wheel 26 that is not driven by the motor 24 and a front wheel speed sensor 11 that measures the front wheel 26 rotational speed. At the rear is mounted a rear wheel 28 that is driven by the motor 24 and a rear wheel speed sensor 14 that measures the rear wheel 28 rotational speed.

The traction control system is controlled by the operator using the system control switch 20. The operator can turn the system on or off as well as selecting several preset degrees of allowable rear wheel 28 slippage. The operator can also turn the rear suspension damping feature on or off. The traction control computer 16 which is powered by the vehicle electrical system 30 receives input from the front wheel speed sensor 11 and the rear wheel speed sensor 14. It then determines if the rear wheel 28 is maintaining traction or slipping. If the rear wheel 28 is maintaining traction and not slipping the rear wheel 28 rotational speed will be equal to the front wheel 26 rotational speed. If the rear wheel 28 rotational speed exceeds the front wheel 26 rotational speed it means the rear wheel 28 has lost traction and is slipping. Depending on the selected system setting, if the rear wheel 28 begins slipping the traction control computer 16 sends a signal to the motor control unit 32 to retard power to the rear wheel 28 until it regains traction and ceases slipping. If the rear suspension damping feature is turned on the traction control computer 16 sends a signal to the rear shock absorbing system 18 to adjust damping as appropriate.

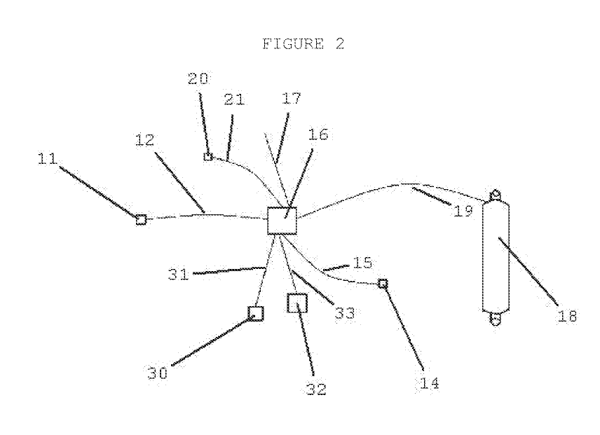

FIG. 2 is a detail view of a schematic of the components and connections of the invention when installed in a two wheel motorcycle or three wheel motorcycle having two wheels in the front and one wheel in the rear. It shows the traction control system connected to the vehicle electrical system 30 by the wire to vehicle electrical system 31, to the motor control unit 32 by the wire to the motor control unit 33, to the front wheel speed sensor 11 by the connection to the front wheel speed sensor 12, to the rear wheel speed sensor 14 by the connection to the rear wheel speed sensor 15, to the rear shock absorbing system 18 by the wire to the rear shock absorbing system 19 and to the system control switch 20 by the wire to the system control switch 21.

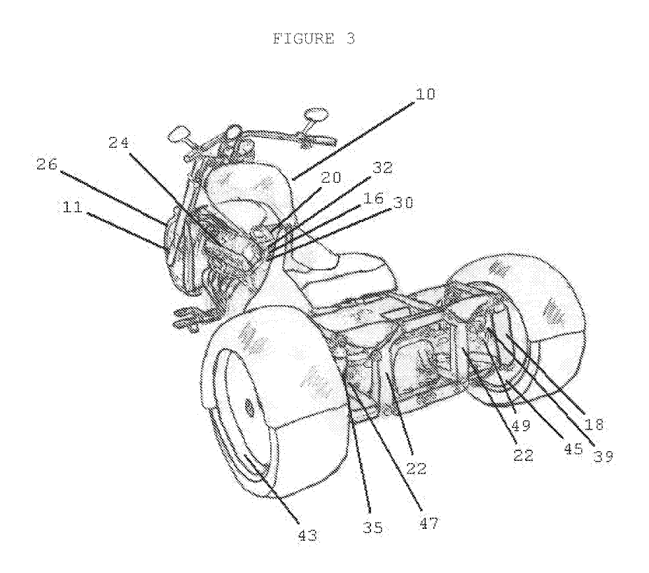

FIG. 3 is a left view of a complete three wheel motorcycle 10 with the invention installed and shows the configuration of the invention when installed in a three wheeled motorcycle having one wheel in the front and two wheels in the rear which contains a frame 22 which provides structure and a place to attach other components. At the front end is mounted a front wheel 26 that is not driven by the motor 24 and a front wheel speed sensor 11 that measures the front wheel 26 rotational speed. At the left rear is mounted a left rear wheel 43 and a left rear wheel speed sensor 47 that measures the left rear wheel's 43 rotational speed. At the right rear is mounted a right rear wheel 45 and a right rear wheel speed sensor 49 that measures the right rear wheel's 45 rotational speed. Both rear wheels are driven by the motor 24.

The traction control system is controlled by the operator using the system control switch 20. The operator can turn the system on or off as well as selecting several preset degrees of allowable rear wheel 28 slippage. The operator can also turn the rear suspension damping feature on or off. The traction control computer 16 which is powered by the vehicle electrical system 30 receives input from the front wheel speed sensor 11 and the left and right rear wheel 45 speed sensors. It then determines if each rear wheel 28 is maintaining traction or slipping. If the rear wheel 28 is maintaining traction and not slipping the rear wheel 28 rotational speed equals the front wheel 26 rotational speed. If the rear wheel 28 rotational speed exceeds the front wheel 26 rotational speed it means the rear wheel 28 has lost traction and is slipping. Depending on the selected system setting, if either rear wheel 28 begins slipping the traction control computer 16 sends a signal to the motor control unit 32 to retard power from the motor to the rear wheel 28 until it regains traction and ceases slipping. If the rear braking feature is turned on a signal is simultaneously sent to the appropriate rear braking unit to engage the brake to stop the wheel from slipping. If the rear suspension damping feature is turned on the traction control computer 16 sends a signal to the rear shock absorbing system 18 to adjust damping as appropriate.

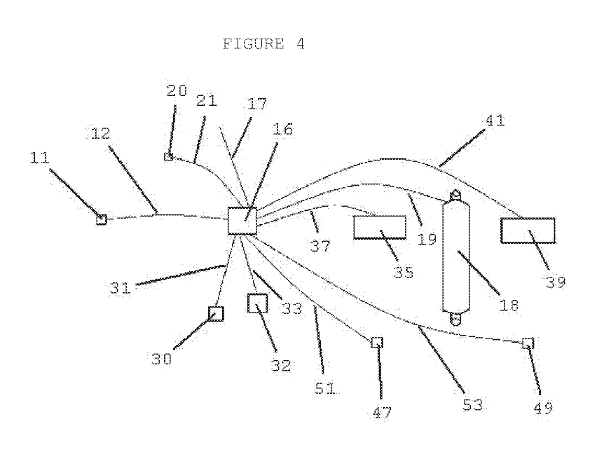

FIG. 4 is a detail view of a schematic of the components and connections of the invention when installed in a three wheeled motorcycle having one wheel in the front and two wheels in the rear. It shows the traction control system connected to the vehicle electrical system 30 by the wire to vehicle electrical system 31, to the motor control unit 32 by the wire to the motor control unit 33, to the front wheel speed sensor 11 by the connection to the front wheel speed sensor 12, to the left rear wheel speed sensor 47 by the connection to left rear wheel speed sensor 51, to the right rear wheel speed sensor 49 by connection to right rear wheel speed sensor 53, to the rear shock absorbing system 18 by the wire to rear shock absorbing system 19, to the left rear braking unit 35 by the wire to left rear braking unit 37, to the right rear braking unit 39 by the wire to right rear braking unit 41 and to the system control switch 20 by the wire to system control switch 21.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A motorcycle traction control system for increasing rear wheel traction and limiting and/or preventing the rear wheel from slipping under hard acceleration and/or slippery road conditions, comprising:
means for controlling entire system based in setting selected and operator's acceleration;
means for allowing the operator to control the traction control system including turning it on and off and selecting the desired pre-set traction setting;
means for measuring the rotational speed of the front wheel;
means for connecting the traction control computer to the front wheel speed sensor, electrically connected to said means for measuring the rotational speed of the front wheel, and electrically connected to said means for controlling entire system based in setting selected and operator's acceleration;
means for measuring rear wheel rotation speed;
means for providing shock absorbtion for the rear of the vehicle and stiffens when commanded to do so by the traction control computer;
means for providing braking for the left rear wheel;
means for providing braking for the right rear wheel;
means for controlling the function of the motor;
means for connecting the traction control computer to the motor control unit, electrically connected to said means for controlling the function of the motor, and electrically connected to said means for controlling entire system based in setting selected and operator's acceleration;
means for measuring left rear wheel rotation speed;
means for measuring right rear wheel rotation speed; and
means for connecting right rear wheel speed sensor to the traction control computer.

2. The motorcycle traction control system in accordance with claim 1, wherein said means for controlling entire system based in setting selected and operator's acceleration comprises a setting for system off, setting for no real wheel slip, one or more preset settings for allowable percentage wheel slip traction control computer.

3. The motorcycle traction control system in accordance with claim 1, wherein said means for allowing the operator to control the traction control system including turning it on and off and selecting the desired pre-set traction setting comprises an off position position, position for no wheel slip, position for one or more preset settings for allowable percentage wheel slip system control switch.

4. The motorcycle traction control system in accordance with claim 1, wherein said means for measuring the rotational speed of the front wheel comprises a front wheel speed sensor.

5. The motorcycle traction control system in accordance with claim 1, wherein said means for connecting the traction control computer to the front wheel speed sensor comprises a connector to front wheel speed sensor.

6. The motorcycle traction control system in accordance with claim 1, wherein said means for measuring rear wheel rotation speed comprises a rear wheel speed sensor.

7. The motorcycle traction control system in accordance with claim 1, wherein said means for providing shock absorbtion for the rear of the vehicle and stiffens when commanded to do so by the traction control computer comprises a rear shock absorbing system.

8. The motorcycle traction control system in accordance with claim 1, wherein said means for providing braking for the left rear wheel comprises a left rear braking unit.

9. The motorcycle traction control system in accordance with claim 1, wherein said means for providing braking for the right rear wheel comprises a right rear braking unit.

10. The motorcycle traction control system in accordance with claim 1, wherein said means for controlling the function of the motor comprises a receives input from the traction control computer motor control unit.

11. The motorcycle traction control system in accordance with claim 1, wherein said means for connecting the traction control computer to the motor control unit comprises a wire to motor control unit.

12. The motorcycle traction control system in accordance with claim 1, wherein said means for measuring left rear wheel rotation speed comprises a left rear wheel speed sensor.

13. The motorcycle traction control system in accordance with claim 1, wherein said means for measuring right rear wheel rotation speed comprises a right rear wheel speed sensor.

14. A motorcycle traction control system for increasing rear wheel traction and limiting and/or preventing the rear wheel from slipping under hard acceleration and/or slippery road conditions, comprising:
a setting for system off, setting for no rear wheel slip, one or more preset settings for allowable percentage wheel slip traction control computer, for controlling entire system based in setting selected and operator's acceleration;
an off position position, position for no wheel slip, position for one or more preset settings for allowable percentage wheel slip system control switch, for allowing the operator to control the traction control system including turning it on and off and selecting the desired pre-set traction setting;
a front wheel speed sensor, for measuring the rotational speed of the front wheel;
a connector to front wheel speed sensor, for connecting the traction control computer to the front wheel speed sensor, electrically connected to said front wheel speed sensor, and electrically connected to said traction control computer;
a rear wheel speed sensor, for measuring rear wheel rotation speed;
a rear shock absorbing system, for providing shock absorbtion for the rear of the vehicle and stiffens when commanded to do so by the traction control computer;
a left rear braking unit, for providing braking for the left rear wheel;
a right rear braking unit, for providing braking for the right rear wheel;
a receives input from the traction control computer motor control unit, for controlling the function of the motor;
a wire to motor control unit, for connecting the traction control computer to the motor control unit, electrically connected to said motor control unit, and electrically connected to said traction control computer;
a left rear wheel speed sensor, for measuring left rear wheel rotation speed;
a right rear wheel speed sensor, for measuring right rear wheel rotation speed; and
a three wheel motorcycle only, connected to traction control computer, connected to left rear wheel speed sensor, hard wired or wireless connector to right rear wheel speed sensor, for connecting right rear wheel speed sensot to the traction control computer.

15. A motorcycle traction control system for increasing rear wheel traction and limiting and/or preventing the rear wheel from slipping under hard acceleration and/or slippery road conditions, comprising:
a setting for system off, setting for no rear wheel slip, one or more preset settings for allowable percentage wheel slip traction control computer, for controlling entire system based in setting selected and operator's acceleration;
an off position position, position for no wheel slip, position for one or more preset settings for allowable percentage wheel slip system control switch, for allowing the operator to control the traction control system including turning it on and off and selecting the desired pre-set traction setting;
a front wheel speed sensor, for measuring the rotational speed of the front wheel;
a connector to front wheel speed sensor, for connecting the traction control computer to the front wheel speed sensor, electrically connected to said front wheel speed sensor, and electrically connected to said traction control computer;
a rear wheel speed sensor, for measuring rear wheel rotation speed;
a rear shock absorbing system, for providing shock absorbtion for the rear of the vehicle and stiffens when commanded to do so by the traction control computer;
a left rear braking unit, for providing braking for the left rear wheel;
a right rear braking unit, for providing braking for the right rear wheel;
a receives input from the traction control computer motor control unit, for controlling the function of the motor;
a wire to motor control unit, for connecting the traction control computer to the motor control unit, electrically connected to said motor control unit, and electrically connected to said traction control computer;
left rear wheel speed sensor, for measuring left rear wheel rotation speed;
right rear wheel speed sensor, for measuring right rear wheel rotation speed; and
a three wheel motorcycle only, connected to traction control computer, connected to left rear wheel speed sensor, hard wired or wireless connector to right rear wheel speed sensor, for connecting right rear wheel speed sensot to the traction control computer.
